(19) United States
(12) Patent Application Publication
(10) Pub. No.: US 2019/0281947 A1
(43) Pub. Date: Sep. 19, 2019

(54) ARTIFICIAL NAIL AND TRANSFER ASSEMBLY SET FOR ARTIFICIAL NAIL

(71) Applicant: JC KOREA CORP., Gyeonggi-do (KR)

(72) Inventors: Dong Sung KIM, Gyeonggi-do (KR); Kyoung Sik CHOI, Gyeonggi-do (KR)

(73) Assignee: JC KOREA CORP., Gyeonggi-do (KR)

(21) Appl. No.: 16/301,020

(22) PCT Filed: Dec. 6, 2017
(86) PCT No.: PCT/KR2017/014252

§ 371 Date: Nov. 13, 2018

(30) Foreign Application Priority Data
Dec. 7, 2016 (KR) 10-2016-0166100

(51) Int. Cl. A45D 31/00; A45D 29/00; A45D 29/18; B32B 7/12; B32B 27/06; B32B 7/06

(52) U.S. Cl. CPC A45D 31/00; A45D 29/001; A45D 29/18; B32B 2451/00; B32B 27/06; B32B 7/06; B32B 7/12

(57) ABSTRACT

Disclosed are an artificial nail and a transfer assembly set for an artificial nail. The artificial nail according to an embodiment of the present disclosure includes a design layer having a plurality of first die-cut lines, and an adhesion layer provided below the design layer, and which is adhered to a nail main body.

### TECHNICAL FIELD

The present disclosure relates to an artificial nail and a transfer assembly set for an artificial nail, and more particularly, to an artificial nail with a design layer having a plurality of die-cut lines attached to a nail main body having a 3-dimensional curve and a transfer assembly set for an artificial nail.

### BACKGROUND ART

A user attaches artificial nails having various designs to her nails to change the length or shape of the nails.

In general, a design layer that is attached to a nail main body of an artificial nail is formed from a film of a stiff material and has a flat shape, so wrinkles occur in the design layer while the design layer is attached to the nail main body having a 3-dimensional curve.

Accordingly, to solve the above-described problem, conventionally, an operation of removing wrinkles is performed after attaching the design layer to the nail main body.

However, because the user has to manually remove wrinkles occurred in the design layer, novices having a low ability to perform an operation spend a long operation time in removing wrinkles and there is a rise in production cost of artificial nails. Additionally, the design layer may be contaminated with impurities in the process of removing wrinkles.

Accordingly, there is a need for an approach to preventing wrinkles from occurring when attaching the design layer to the nail main body.

### DISCLOSURE

### Technical Problem

Therefore, the present disclosure is directed to providing an artificial nail for preventing wrinkles from occurring in attaching a design layer to a nail main body of the artificial nail and a transfer assembly set for an artificial nail.

### Technical Solution

According to an aspect of the present disclosure, there is provided an artificial nail including a design layer having a plurality of first die-cut lines, and an adhesive layer provided below the design layer, and which is adhered to a nail main body.

One side end of the first die-cut lines may cut an outer surface of the design layer, and the other side end of the design layer may cut the design layer inwards from lengthwise direction and widthwise direction outer surfaces of the design layer by 5% to 50% relative to a length and a width of the design layer.

A total length of the first die-cut lines formed in the design layer may be 3-500% relative to an outer surface length of the design layer, and a total area of the first die-cut lines may be 0.5-25% relative to a surface area of the design layer.

The first die-cut lines may include at least one of linear die-cut lines having a predetermined width, tapered die-cut lines with a decreasing or increasing width inwards from an outer surface of the design layer, and curved die-cut lines having a predetermined width.

The design layer may include a plurality of unit design layers divided by the plurality of first die-cut lines, and which is adhered to the nail main body by a medium of the adhesive layer.

The design layer may further include a connecting part formed between the first die-cut lines to prevent the plurality of unit design layers from being separated.

The artificial nail may further include a base layer interposed between the design layer and the adhesive layer or stacked on an upper surface of the design layer, the base layer in which a plurality of second die-cut lines is formed at corresponding locations to the plurality of first die-cut lines of the design layer.

The design layer may be a transparent or opaque hologram film or sheet, and the base layer may be a transparent or opaque film or sheet printed with at least one color ink or deposited with a metal thin film.

The adhesive layer may have a plurality of third die-cut lines formed at corresponding locations to the plurality of first die-cut lines of the design layer.

According to another aspect of the present disclosure, there is provided a transfer assembly set for an artificial nail including a sticker including a design layer having a plurality of first die-cut lines, an adhesive layer provided below the design layer and peelably adhered to a release sheet, and a base layer interposed between the design layer and the adhesive layer or stacked on an upper surface of the design layer, and a transfer body including a main body part and an adhesion part provided below the main body part, and to which the design layer, the base layer and the adhesive layer are integrally adhered when pressing the upper surface of the design layer or the base layer adhered to the release sheet upon contact, wherein the transfer body peels the design layer, the base layer and the adhesive layer from the release sheet, and attaches the design layer, the base layer and the adhesive layer to a nail main body of an artificial nail by pressing the design layer, the base layer and the adhesive layer onto the nail main body upon contact.

The tackiness between the adhesive layer and the nail main body may be larger than the tackiness between the design layer or the base layer and the adhesion part.

The tackiness of the adhesive layer may be 300-25,000 gf/in, and the tackiness of the adhesion part may be 5-15,000 gf/in.

The adhesion part may have tackiness, and may be formed from a material including one selected from olefin resin, acrylic resin, urethane resin, silicone resin and rubber or mixtures thereof.

The adhesion part may be manufactured in a form of cushioned sheet or foam.

The transfer body may further include a main body part, and a pressing part that extends from the main body part and is bent, with a lower surface to which the adhesion part is attached and an upper surface having a flat or curved shape to which pressing is applied, and the main body part may be manufactured from a material that is capable of elastic recovery when pressing the design layer or the base layer upon contact.

The pressing part may be provided at two ends of the main body part and each differently sized to match a size of the design layer or the base layer, and when the pressing part has a curved shape, a widthwise direction radius of curvature of the pressing part may be 10-360 mm and a lengthwise direction radius of curvature of the pressing part may be 30-400 mm.

The surface tension of the release sheet may be 36 dyne/cm or less per unit width.

### Advantageous Effects

The embodiments of the present disclosure form a plurality of first die-cut lines in a design layer that is attached to a nail main body of an artificial nail, thereby preventing wrinkles from occurring in the design layer when attaching the design layer to the nail main body.

Additionally, the embodiments of the present disclosure provide varying glitters and colors according to viewing angles by the plurality of first die-cut lines formed in the design layer, thereby improving the aesthetic appearance.

### DESCRIPTION OF DRAWINGS

FIG. 1 is a perspective view showing a transfer assembly set for an artificial nail according to the present disclosure.

FIG. 2 is a cross-sectional view showing a transfer body according to another embodiment of the present disclosure.

FIG. 3 is a cross-sectional view showing a sticker according to the present disclosure.

FIG. 4 is a plane view showing a design layer of a sticker according to the present disclosure.

FIGS. 5A and 5B are side views showing the radius of curvature of a pressing part according to the present disclosure.

FIG. 6 is a flowchart showing a sticker transfer method according to the present disclosure.

FIG. 7 is an operation state diagram showing an operation of peeling a design layer off from a sticker according to the present disclosure.

FIG. 8 is an operation state diagram showing an operation of attaching a design layer to a nail main body according to the present disclosure.

FIG. 9 is a perspective view showing an artificial nail according to the present disclosure.

FIG. 10 is a cross-sectional view showing an artificial nail according to the present disclosure.

### BEST MODE

To fully understand the present disclosure, the operational advantages of the present disclosure and the objects achieved by the practice of the present disclosure, a reference should be made to the accompanying drawings illustrating the preferred embodiments of the present disclosure and the content stated in the accompanying drawings.

Hereinafter, the present disclosure is described in detail by describing the preferred embodiment of the present disclosure with reference to the accompanying drawing. Like reference signs presented in each drawing denote like elements.

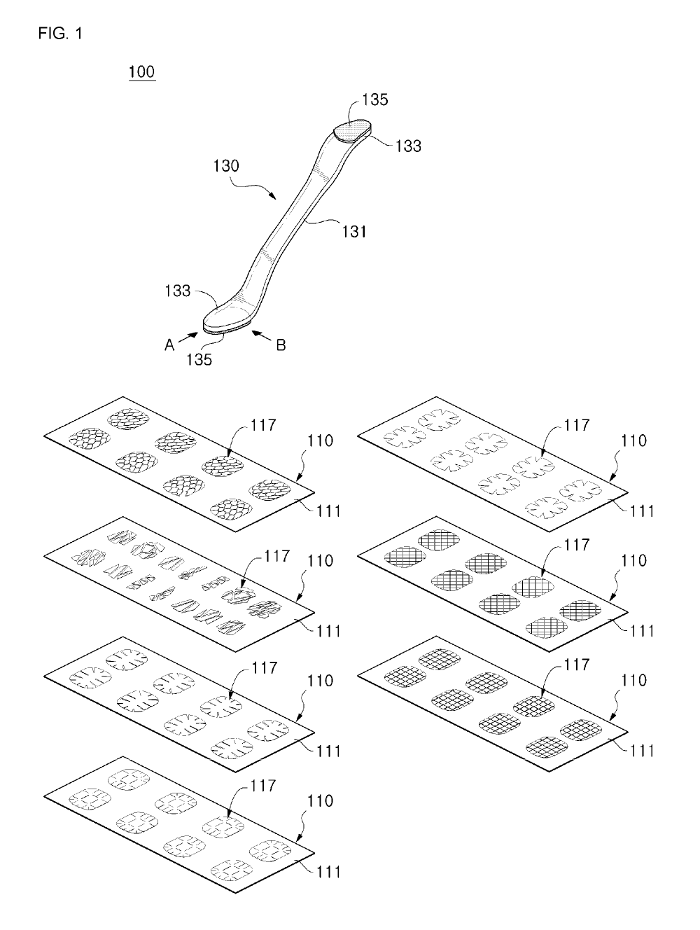

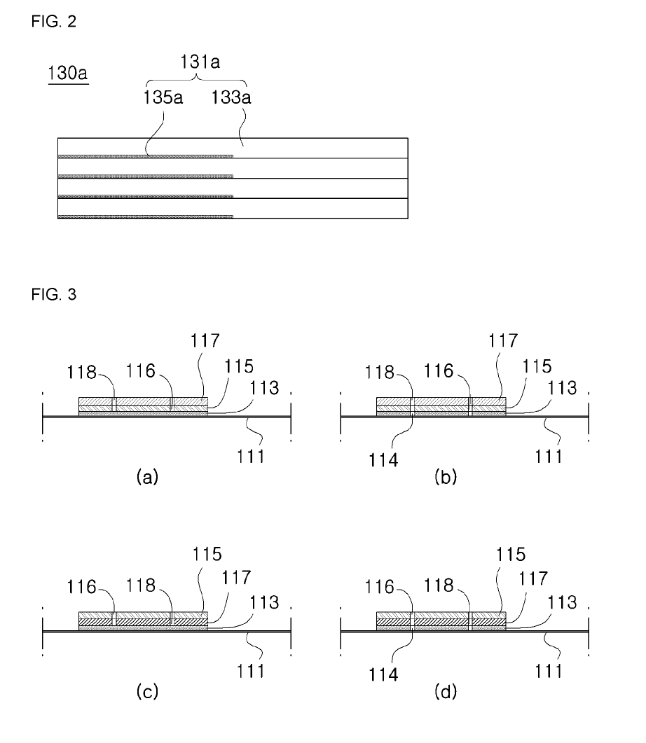

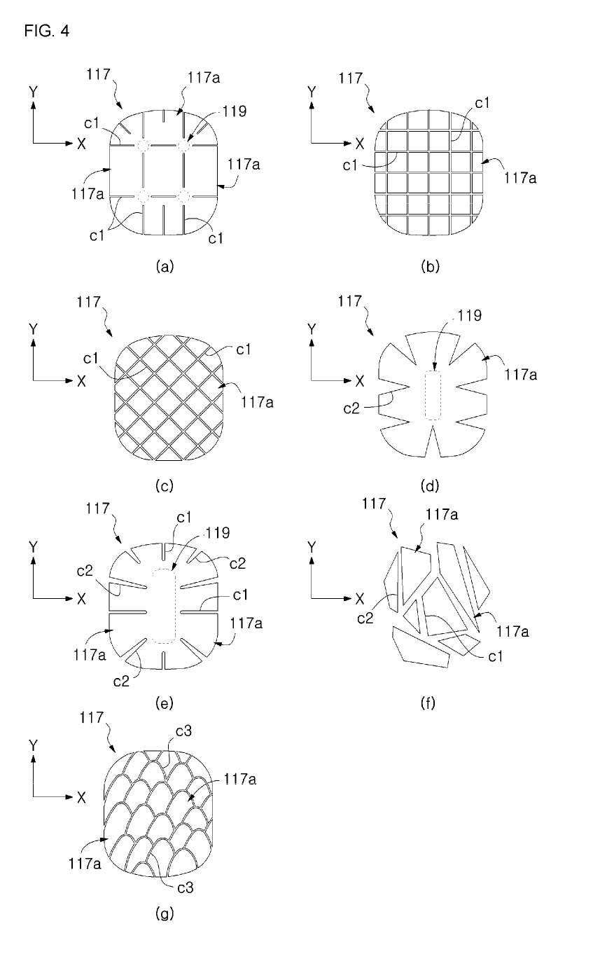

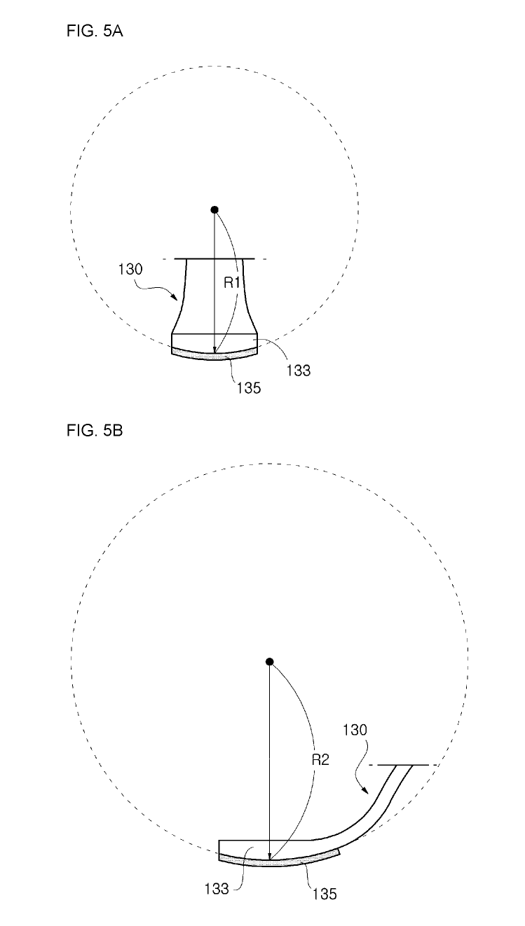

FIG. 1 is a perspective view showing a transfer assembly set for an artificial nail according to the present disclosure, FIG. 2 is a cross-sectional view showing a transfer body according to another embodiment of the present disclosure, FIG. 3 is a cross-sectional view showing a sticker according to the present disclosure, FIG. 4 is a plane view showing a design layer of a sticker according to the present disclosure, and FIGS. 5A and 5B are side views showing the radius of curvature of a pressing part according to the present disclosure.

Referring to FIGS. 1 to 3, the transfer assembly set 100 for an artificial nail according to the present disclosure includes a sticker 110 having a design layer 117, a base layer 115 provided on the lower surface of the design layer 117 and an adhesive layer 113 provided on the lower surface of the base layer 115 and peelably adhered to a release sheet 111, and a transfer body 130, 130a to integrally peel the design layer 117, the base layer 115 and the adhesive layer 113 adhered to the sticker 110 and attach the peeled design layer, base layer and adhesive layer 117, 115, 113 to a nail main body M of an artificial nail 200. Additionally, the base layer 115 according to this embodiment may be provided on the upper layer of the design layer 117.

The transfer assembly set 100 for an artificial nail according to this embodiment integrally adheres the design layer 117, the base layer 115 and the adhesive layer 113 to the transfer body 130, 130a, transfers the transfer body 130, 130a above the nail main body M, and presses the design layer 117, the base layer 115 and the adhesive layer 113 onto the nail main body M upon contact, so that the design layer 117, the base layer 115 and the adhesive layer 113 can be easily attached to the nail main body M using the transfer body 130, 130a.

Referring to FIG. 3, the sticker 110 according to this embodiment has the adhesive layer 113 peelably adhered to the upper surface of the release sheet 111, and the base layer 115 and the design layer 117, or the design layer 117 and the base layer 115 stacked on the upper surface of the adhesive layer 113 in a sequential order.

The release sheet 111 may be manufactured by surface coating with silicone, Teflon and fluorine on a film or a sheet made of one selected from paper, poly vinyl chloride (PVC), polyethylene (PE), polyurethane (PU), polypropylene (PP), polyethylene phthalate (PET), polyolefin elastomer (POE), ethylene-vinyl acetate copolymer (EVA) and acrylic resin or polymers thereof.

The adhesive layer 113, the base layer 115 and the design layer 117, or the adhesive layer 113, the design layer 117 and the base layer 115 are stacked on the upper surface of the release sheet 111 in a sequential order. Additionally, the adhesive layer 113, the base layer 115 and the design layer 117 are integrally peeled off from the release sheet 111.

In this embodiment, the surface tension of the release sheet 111 is 36 dyne/cm or less per unit width, to easily peel the adhesive layer 113 off from the release sheet 111 and prevent the tearing and pop-up phenomena of the release sheet 111.

Additionally, the tackiness of the adhesive layer 113 is preferably 300-25,000 gf/in. The tackiness measurement may be performed in accordance with ASTM D3330 180 degree PEEL TEST.

For example, when attaching the adhesive layer 113 having the base layer 115 and the design layer 117 stacked thereon to the nail main body M of the artificial nail 200, in case that the tackiness of the adhesive layer 113 is less than 300 gf/in, the adhesive layer 113 is spaced apart from the nail main body M and it is more likely to be separated from the nail main body M, and in case that the tackiness of the adhesive layer 113 exceeds 25,000 gf/in, the nail main body M may be damaged when the user separates the adhesive layer 113 from the nail main body M for replacement purposes.

Accordingly, the tackiness of the adhesive layer 113 is preferably 300-25,000 gf/in.

In this embodiment, the base layer 115 may be stacked on the upper surface of the adhesive layer 113 as shown in FIGS. 3(A) and 3(B) or on the upper surface of the design layer 117 as shown in FIGS. 3(C) and 3(D).

The base layer 115 may be a film or a sheet made of one selected from poly vinyl chloride (PVC), polyethylene (PE), polyurethane (PU), polypropylene (PP), polyethylene phthalate (PET), polyolefin elastomer (POE), ethylene-vinyl acetate copolymer (EVA) and acrylic resin or polymers thereof.

Additionally, although not shown, a color ink may be printed on the upper surface or the lower surface of the base layer 115 by one selected from screen, offset and gravure printing methods.

In this instance, the entire upper or lower surface of the base layer 115 may be printed in one color, but is not limited thereto, and the entire upper or lower surface of the base layer 115 may be divided into a plurality of areas and each area may be printed in different colors or predetermined colors repeatedly.

The colors printed on the base layer 115 may achieve more unique color reproduction by projection on a transparent hologram film in case that the design layer 117 as described below is formed from a transparent hologram film.

Additionally, although not shown, a metal thin film of aluminum (Al), nickel (Ni) and chrome (Cr) may be deposited on the upper surface and the lower surface of the base layer 115. The metal thin film may be manufactured transparently or opaquely according to the stack thickness. The metal thin film deposited on the base layer 115 can provide a variety of metallic sensations and hologram effects.

In this embodiment, the design layer 117 may be a transparent or opaque film or sheet stacked on the upper surface of the base layer 115 or between the base layer 115 and the adhesive layer 113.

Meanwhile, the design layer 117 may include a transparent hologram film having various hologram patterns and designs formed on one surface of a base film. The hologram film varies colors or designs depending on viewing directions.

Additionally, the base film used in the transparent hologram film may be manufactured from polymer resin that is identical or similar to the material of the base layer 115 described above.

Meanwhile, the design layer 117 formed from a transparent hologram film or sheet has a stiff material, and thus especially when the design layer 117 is attached to the nail main body M having a 3-dimensional (3D) curve, wrinkles may occur in the design layer 117.

Accordingly, in this embodiment, a plurality of first die-cut lines 118 is formed in the design layer 117 to prevent wrinkles from occurring in the design layer 117 when attaching the design layer 117 to the nail main body M. That is, when attaching the design layer 117 of a flat shape to the nail main body M having a 3D curve, wrinkles may occur in the design layer 117 due to the radius of curvature of the nail main body M, and the wrinkles may be prevented by adjusting the length, shape and interval of the first die-cut lines 118 formed in the design layer 117.

Specifically, as shown in FIG. 4, the design layer 117 includes a plurality of unit design layers 117a which is divided by the plurality of first die-cut lines 118 and adhered to the nail main body M by the medium of the adhesive layer 113. That is, the design layer 117 is divided into the plurality of unit design layers 117a by the plurality of first die-cut lines 118.

Additionally, one side end of the first die-cut lines 118 cuts the outer surface of the design layer 117. Additionally, the other side end of the first die-cut lines 118 disposed in the lengthwise direction (Y-direction) of the design layer 117 cuts the design layer 117 inwards from the lengthwise direction (Y-direction) outer surface of the design layer 117 by at least 5% relative to the length of the design layer 117, and the other side end of the first die-cut lines 118 disposed in the widthwise direction (X-direction) of the design layer 117 cuts the design layer 117 inwards from the widthwise direction (X-direction) outer surface of the design layer 117 by at least 5% relative to the width of the design layer 117. In this instance, when the other side ends of the first die-cut lines 118 disposed at two sides of the design layer 117 in lengthwise direction (Y-direction) and widthwise direction (X-direction) are 50% relative to the length and width of the design layer 117, the first die-cut lines 118 cut through the design layer 117 as shown in FIGS. 4(B) and 4(C).

Additionally, the total length of the first die-cut lines 118 formed in the design layer 117 is preferably 3-500% relative to the length of the outer surface of the design layer 117, and the total area of the first die-cut lines 118 is preferably 0.5-25% relative to the surface area of the design layer 117. Here, the total area of the first die-cut lines is the sum of multiplication of the widths and lengths of the first die-cut lines 118 formed in the design layer 117.

When the total length of the first die-cut lines 118 is less than 3% and the total area of the first die-cut lines is less than 0.5%, wrinkles may occur in the design layer 117, and when the total length of the first die-cut lines 118 exceeds 500% and the total area of the first die-cut lines exceeds 25%, the stiffness of the design layer 117 itself may reduce.

Specifically, as shown in FIGS. 4(A), 4(B) and 4(C), the plurality of first die-cut lines 118 may include a plurality of linear die-cut lines c1 having a predetermined width formed in the design layer 117. In FIGS. 4(A) and 4(B), the first die-cut lines 118 go across in the lengthwise direction (Y-direction) and widthwise direction (X-direction) of the design layer 117, and in FIG. 4(C), the first die-cut lines 118 go across in the diagonal direction.

Additionally, as shown in FIG. 4(D), the plurality of first die-cut lines 118 according to another embodiment may include a plurality of tapered die-cut lines c2 formed in the design layer 117 with an increasing or decreasing width inwards from the outer surface of the design layer. Additionally, as shown in FIG. 4(E), the plurality of first die-cut lines 118 according to still another embodiment may include a plurality of linear die-cut lines c1 formed in the design layer 117 and a plurality of tapered die-cut lines c2 formed in the design layer 117.

Meanwhile, as shown in FIGS. 4(A), 4(D) and 4(E), the design layer 117 may further include a connecting part 119 formed between the first die-cut lines 118 to prevent the separation of the plurality of unit design layers 117a.

When the design layer 117 is divided into the plurality of unit design layers 117a by the plurality of first die-cut lines 118, the connecting part 119 is provided to prevent the unit design layers 117a from being separated into pieces by the plurality of first die-cut lines 118. That is, to prevent the design layer 117 from being separated into pieces by two first die-cut lines 118 connected to each other or one first die-cut line 118 passing through the design layer 117 from one side to the other side, in this embodiment, the connecting part 119 is provided between the first die-cut lines 118.

Additionally, as shown in FIG. 4(F), the plurality of first die-cut lines 118 according to still another embodiment include linear die-cut lines c1 and tapered die-cut lines c2 to separate the design layer 117 into a plurality of unit design layers 117a. In this instance, the base layer 115 and the adhesive layer 113 may be provided on the lower surface of each of the separated unit design layers 117a.

Additionally, as shown in FIG. 4(G), the plurality of first die-cut lines 118 according to still another embodiment may include curved die-cut lines c3 having a predetermined width in the design layer 117. In this instance, the design layer 117 may be separated into a plurality of unit design layers 117a by the curved die-cut lines c3, or the design layer 117 may have a connecting part (not shown) between the curved die-cut lines c3 to prevent the separation of the plurality of unit design layers 117a.

Meanwhile, although FIGS. 4(A) to 4(G) show the first die-cut lines 118 formed in the design layer 117 according to this embodiment, the scope of protection of the present disclosure is not limited thereto.

Meanwhile, when the base layer 115 is interposed between the design layer 117 and the adhesive layer 113 as shown in FIG. 3(A), and when the base layer 115 is stacked on the upper surface of the design layer 117 as shown in FIG. 3(C), a plurality of second die-cut lines 116 may be formed in the base layer 115 at locations corresponding to the plurality of first die-cut lines 118 formed in the design layer 117.

The base layer 115 also has a stiff material, so wrinkles may occur in the base layer 115 when the base layer 115 is attached to the nail main body M having a 3D curve, and thus the plurality of second die-cut lines 116 is formed in the base layer 115 at locations corresponding to the first die-cut lines 118.

Additionally, as shown in FIGS. 3(B) and 3(D), a plurality of third cut-die lines 114 may be formed in the adhesive layer 113 at locations corresponding to the plurality of first die-cut lines 118 formed in the design layer 117 and the plurality of second die-cut lines 116 formed in the base layer 115.

In case that a double sided tape is used for the adhesive layer 113, wrinkles may also occur when the double sided tape is attached to the nail main body M having a 3D curve, and thus the plurality of third die-cut lines 114 may be formed in the adhesive layer 113 at locations corresponding to the first die-cut lines 118 and the second die-cut lines 116.

The transfer body 130, 130a according to this embodiment plays a role in easily peeling the design layer 117, the base layer 115 and the adhesive layer 113 adhered to the release sheet 111 integrally off from the release sheet 111, and easily attaching to the nail main body M.

As shown in FIG. 1, the transfer body 130 according to an embodiment includes a main body part 131, a pressing part 133 that extends from the main body part 131 and is bent, and an adhesion part 135 attached to the lower surface of the pressing part 133.

The main body part 131 may be formed in the shape of a long rod to allow the user to hold, but the scope of protection of the present disclosure is not limited thereto, and any shape the user can hold is available.

Additionally, the pressing part 133 extends from one or two ends of the main body part 131 and is bent, and may be formed in a flat shape that allows the user to press the upper surface with a finger.

Additionally, the pressing part 133 may be formed in a curved shape having a predetermined radius of curvature. When the pressing part 133 is formed in a curved shape, as shown in FIG. 5A, a widthwise direction radius of curvature R1 of the pressing part 133 when viewed from the direction A of FIG. 1 may be 10-360 mm, and as shown in FIG. 5B, a lengthwise direction radius of curvature R2 of the pressing part 133 when viewed from the direction B of FIG. 1 may be 30-400 mm.

Additionally, the adhesion part 135 as described below is detachably attached to the lower surface of the pressing part 133.

Additionally, when the pressing part 133 is formed at two ends of the main body part 131, sizes may be different to match the size of the design layer 117 or the base layer 115 of the sticker 110.

Additionally, the adhesion part 135 plays a role in adhering the design layer 117 or the base layer 115 disposed at the topmost of the sticker 110 and integrally peeling the design layer 117, the base layer 115 and the adhesive layer 113 off from the release sheet 111. Additionally, the design layer 117, etc. adhered to the adhesion part 135 is transferred to the upper surface of the nail main body M.

Specifically, the adhesion part 135 comes into contact with the upper surface of the design layer 117 or the base layer 115 adhered to the release sheet 111, the pressing part 133 is pressed with a finger to integrally adhere the design layer 117, the base layer 115 and the adhesive layer 113 to the adhesion part 135, and the design layer 117, etc. is peeled off from the release sheet 111. Additionally, the design layer 117, etc. adhered to the adhesion part 135 comes into contact with the upper surface of the nail main body M, and the pressing part 133 is pressed with a finger to attach the design layer 117, etc. adhered to the adhesion part 135 onto the nail main body M.

The adhesion part 135 may be manufactured in the form of a cushioned sheet or foam. This is to maximize the surface area of the design layer 117 or the base layer 115 adhered to the adhesion part 135 in adhering the design layer 117 or the base layer 115 to the adhesion part 135 by pressing the adhesion part 135, and to prevent the breakage and damage of the design layer 117 or the base layer 115 caused by the adhesion part 135 being pressed

Additionally, the adhesion part 135 may be attached to the entire area or some areas of the lower surface of the pressing part 133.

Additionally, the adhesion part 135 may be formed from a material including one selected from olefin resin, acrylic resin, urethane resin, silicone resin and rubber or mixtures thereof, so that the adhesion part 135 has tackiness.

Additionally, to attach the design layer 117, etc. to the nail main body M, the tackiness between the adhesive layer 113 provided below the design layer 117, etc. and the nail main body M needs to be larger than the tackiness between the design layer 117 or the base layer 115 and the adhesion part 135.

Specifically, the tackiness of the adhesion part 135 is preferably 5-15,000 gf/in.

For example, when attaching the design layer 117, etc. to the nail main body M, in case that the tackiness of the adhesion part 135 is less than 5 gf/in, it may not be easy to integrally peel the design layer 117, the base layer 115 and the adhesive layer 113 off from the release sheet 111, and in case that the tackiness of the adhesion part 135 exceeds 15,000 gf/in, the percentage of transfer for attaching the design layer 117, etc. to the nail main body M may be reduced. Accordingly, the tackiness of the adhesion part 135 is preferably 5-15,000 gf/in.

Meanwhile, when adhering the design layer 117, etc. to the adhesion part 135 or attaching the design layer 117, etc. adhered to the adhesion part 135 onto the nail main body M, the user holds the main body part 131 and presses the pressing part 133 with a finger to adhere the design layer 117, etc. to the adhesion part 135 or attach the design layer 117, etc. to the nail main body M. In this way, when repeatedly pressing the design layer 117, etc. upon contact, the main body part 131 needs to be resiliently recovered after pressed. To this end, the main body part 131 is manufactured from a material capable of elastic recovery.

For example, the main body part 131 may be formed from a material including one selected from olefin resin, acrylic resin, urethane resin, silicone resin and rubber or mixtures thereof.

Meanwhile, as shown in FIG. 2, the transfer body 130a according to another embodiment includes a plurality of unit transfer bodies 131a stacked in the heightwise direction. That is, a plurality of unit transfer bodies 131a is stacked in the heightwise direction to form a transfer body 130a. Additionally, each unit transfer body 131a includes a main body part 133a and an adhesion part 135a attached to the lower surface of the main body part 133a.

The main body part 133a may be a film or a sheet made of one selected from poly vinyl chloride (PVC), polyethylene (PE), polyurethane (PU), polypropylene (PP), polyethylene phthalate (PET), polyolefin elastomer (POE), ethylene-vinyl acetate copolymer (EVA) and acrylic resin or polymers thereof. Additionally, the adhesion part 135a according to another embodiment is the same as the above-described adhesion part 135 according to an embodiment, and its detailed description is omitted herein.

The process of transferring the design layer 117, etc. using the transfer body 130a according to another embodiment includes contacting the adhesion part 135a with the upper surface of the design layer 117 or the base layer 115 adhered to the release sheet 111, pressing the main body part 133a disposed on the adhesion part 135a with a finger to integrally adhere the design layer 117, the base layer 115 and the adhesive layer 113 to the adhesion part 135a, and peeling the design layer 117, etc. off from the release sheet 111. Additionally, the design layer 117, etc. adhered to the adhesion part 135a comes into contact with the upper surface of the nail main body M, and the main body part 133a is pressed with a finger to attach the design layer 117, etc. adhered to the adhesion part 135a onto the nail main body M. Meanwhile, the adhesion part 135a that constitutes the transfer body 130a according to another embodiment is the same as the process of transferring the design layer 117, etc. using the transfer body 130 according to an embodiment as described above, and its detailed description is omitted herein.

In this way, when the adhesion part 135a is repeatedly used, the tackiness of the adhesion part 135a reduces, and when the tackiness of the adhesion part 135a reduces, an operation of separating the unit transfer body 131a having the corresponding adhesion part 135a from the transfer body 130a and attaching the design layer 117, etc. to the nail main body M using an adhesion part 135a provided in a new unit transfer body 131a is performed.

A sticker transfer method using the transfer assembly set 100 for an artificial nail according to the present disclosure as configured above is described as below.

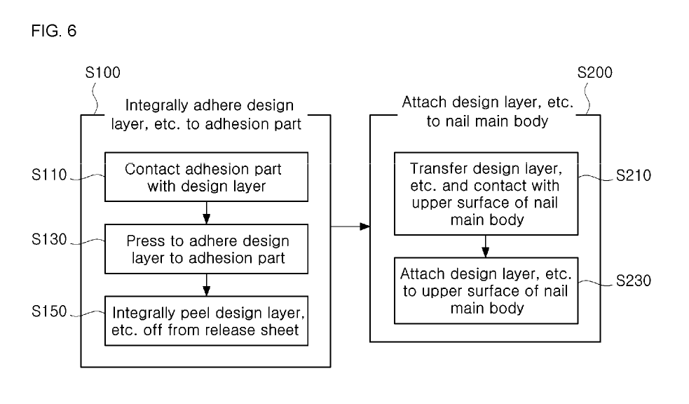

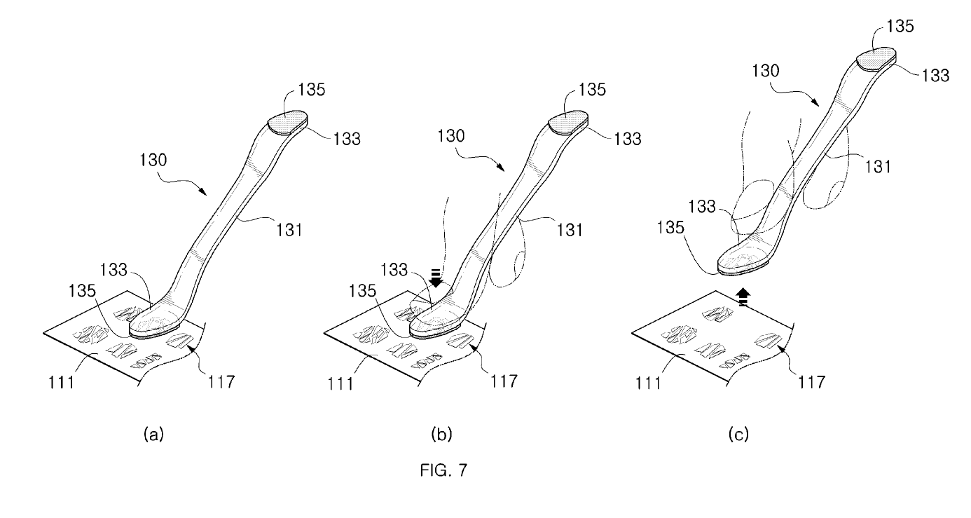

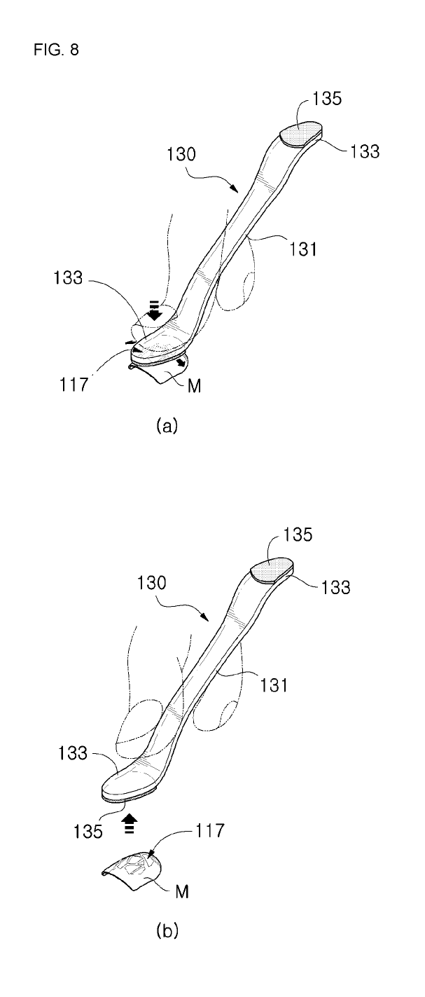

FIG. 6 is a flowchart showing a sticker transfer method according to the present disclosure, FIG. 7 is an operation state diagram showing an operation of peeling a design layer off from a sticker according to the present disclosure, and FIG. 8 is an operation state diagram showing an operation of attaching a design layer to a nail main body according to the present disclosure. Hereinafter, a description is provided taking a case in which the transfer body 130 according to an embodiment is used, and the adhesive layer 113, the base layer 115 and the design layer 117 are stacked on the release sheet 111 in a sequential order as an example.

Referring to FIG. 6, the design layer 117, the base layer 115 and the adhesive layer 113 integrally adhered to the release sheet 111 of the sticker 110 by the medium of the adhesive layer 113 are adhered to the adhesion part 135 of the transfer body 130 (S100).

Specifically, the operation (S100) of integrally adhering the design layer 117, the base layer 115 and the adhesive layer 113 to the adhesion part 135 includes, as shown in FIG. 7(A), first, contacting the adhesion part 135 provided on the lower surface of the pressing part 133 provided in the transfer body 130 with the upper surface of the design layer 117 (S110).

Additionally, as shown in FIG. 7(B), with the adhesion part 135 being in contact with the design layer 117, the upper surface of the pressing part 133 is pressed to adhere the design layer 117 to the adhesion part 135 (S130).

Additionally, as shown in FIG. 7(C), with the design layer 117, etc. being integrally adhered to the adhesion part 135, the transfer body 130 is lifted up to peel the design layer 117, etc. off from the release sheet 111 of the sticker 110 (S150).

Subsequently, the transfer body 130 having the design layer 117, etc. integrally adhered thereto is transferred to the nail main body M, and the design layer 117, etc. is attached to the nail main body M (S200).

Specifically, the operation (S200) of attaching the design layer 117, etc. to the nail main body M includes, as shown in FIG. 8(A), first, transferring the transfer body 130 having the design layer 117, etc. adhered thereto above the nail main body M, and contacting the adhesive layer 113 provided below the design layer 117 with the upper surface of the target (S210).

Additionally, as shown in FIG. 8(B), the upper surface of the pressing part 133 is pressed, the pressing part 133 and the adhesion part 135 move along the curve of the nail main body M to attach the design layer 117, etc. to the upper surface of the nail main body M, and the transfer body 130 is lifted up (S230).

A sticker transfer method using the transfer assembly set 100 for an artificial nail according to the present disclosure as described above can easily attach the design layer 117, etc. to the nail main body M having a 3D curve without wrinkles only by the operation of adhering the design layer 117 to the adhesion part 135 of the transfer body 130, integrally peeling the design layer 117, the base layer 115 and the adhesive layer 113 off from the release sheet 111, transferring the design layer 117, etc. adhered to the adhesion part 135 to the nail main body M, and pressing the design layer 117, etc. onto the upper surface of the nail main body M upon contact.

Additionally, the design layer 117, etc. adhered to the sticker 110 can be easily attached to the nail main body M using the transfer body 130, thereby reducing the operation time and improving the operation efficiency.

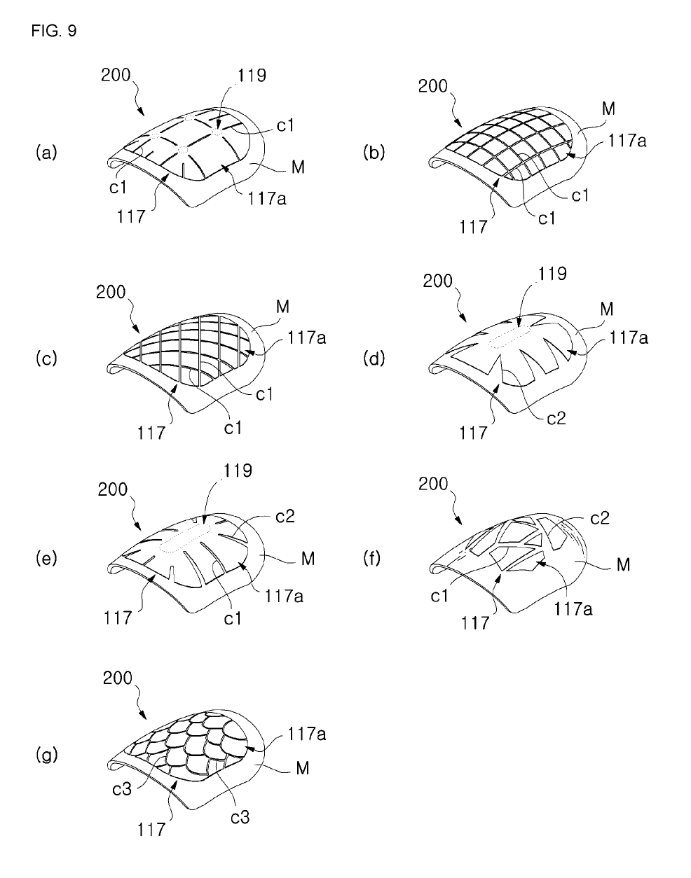

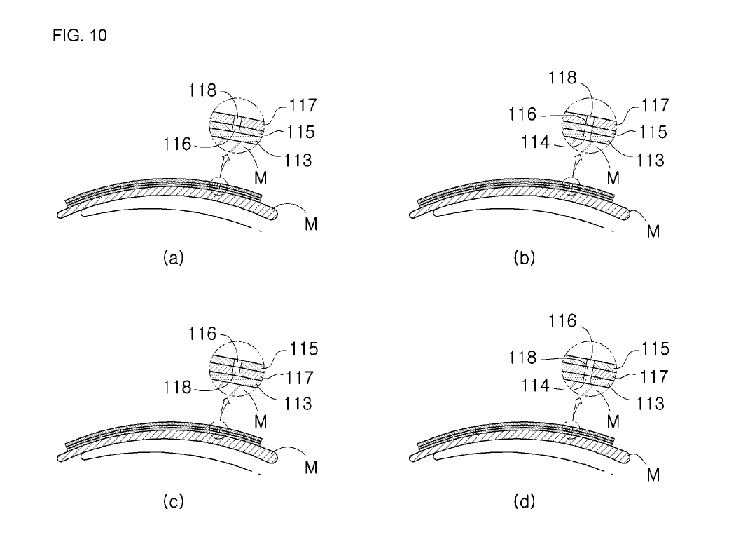

FIG. 9 is a perspective view showing an artificial nail according to the present disclosure, and FIG. 10 is a cross-sectional view showing an artificial nail according to the present disclosure.

FIGS. 9(A) to 9(C) show the artificial nail 200 with the design layer 117 having the linear die-cut lines c1 of the first die-cut lines 118 attached to the nail main body M as shown in FIGS. 4(A) to 4(C). Additionally, FIG. 9(A) shows the connecting part 119 provided between the first die-cut lines 118 as shown in FIG. 4(A).

Additionally, FIG. 9(D) shows the artificial nail 20 with the design layer 117 having the tapered die-cut lines c2 of the first die-cut lines 118 and the connecting part 119 attached to the nail main body M as shown in FIG. 4(D).

Additionally, FIG. 9(E) shows the artificial nail 200 with the design layer 117 having the linear die-cut lines c1 and the tapered die-cut lines c2 of the first die-cut lines 118 and the connecting part 119 attached to the nail main body M as shown in FIG. 4(E).

Additionally, FIG. 9(F) shows the artificial nail 200 with the design layer 117 attached to the nail main body M, the design layer 117 having the linear die-cut lines c1 and the tapered die-cut lines c2 of the first die-cut lines 118 passing through the design layer 117 from one side to the other side so that the design layer 117 is divided into the plurality of unit design layers 117a as shown in FIG. 4(F).

Additionally, FIG. 9(G) shows the artificial nail 200 with the design layer 117 having the curved die-cut lines c3 of the first die-cut lines 118 attached to the nail main body M as shown in FIG. 4(G).

Additionally, FIG. 10(A) shows that the adhesive layer 113, the base layer 115 and the design layer 117 are stacked on the upper surface of the nail main body M in a sequential order, and the first die-cut lines 118 and the second die-cut lines 116 are respectively formed in the design layer 117 and the base layer 115.

Additionally, FIG. 10(B) shows that the adhesive layer 113, the base layer 115 and the design layer 117 are stacked on the upper surface of the nail main body M in a sequential order, and the first die-cut lines 118, the second die-cut lines 116 and the third die-cut lines 114 are respectively formed in the design layer 117, the base layer 115 and the adhesive layer 113.

Additionally, FIG. 10(C) shows that the adhesive layer 113, the design layer 117 and the base layer 115 are stacked on the upper surface of the nail main body M in a sequential order, and the second die-cut lines 116 and the first die-cut lines 118 are respectively formed in the base layer 115 and the design layer 117.

Additionally, FIG. 10(D) shows that the adhesive layer 113, the design layer 117 and the base layer 115 are stacked on the upper surface of the nail main body M in a sequential order, and the second die-cut lines 116, the first die-cut lines 118 and the third die-cut lines 114 are respectively formed in the base layer 115, the design layer 117 and the adhesive layer 113.

As described above, the artificial nail 200 according to the present disclosure is attached to the nail main body M without wrinkles by the plurality of first die-cut lines 118 formed in the design layer 117, and the plurality of unit design layers 117a divided by the plurality of first die-cut lines 118 provides varying glitters and colors according to viewing angles, thereby improving the aesthetic appearance.

The sticker transfer method using the transfer assembly set for an artificial nail can easily attach the design layer 117, etc. to the nail main body M having a 3D curve without wrinkles only by the operation of adhering the design layer 117 or the base layer 115 to the adhesion part 135 of the transfer body 130, integrally peeling the design layer 117, the base layer 115 and the adhesive layer 113 off from the release sheet 111, transferring the design layer 117, etc. adhered to the adhesion part 135 to the nail main body M, and pressing the design layer 117, etc. onto the upper surface of the nail main body M upon contact. Additionally, it is possible to easily attach the design layer 117, etc. adhered to the sticker 110 onto the nail main body M using the transfer body 130, thereby reducing the operation time and improving the operation efficiency.

It is obvious to those having ordinary skill in the art that the present disclosure is not limited to the disclosed embodiments and various modifications and variations may be made thereto without departing from the spirit and scope of the present disclosure. Accordingly, it should be noted that such modifications or variations fall within the scope of the appended claims.

### INDUSTRIAL APPLICABILITY

The present disclosure forms the die-cut lines in the design layer that is attached to the nail main body, thereby preventing wrinkles from occurring in attaching the design layer to the nail main body, and provides varying glitters and colors according to viewing angles, thereby improving the aesthetic appearance.

1. An artificial nail, comprising:
a design layer having a plurality of first die-cut lines; and
an adhesive layer provided below the design layer, and which is adhered to a nail main body.

2. The artificial nail according to claim 1, wherein one side end of the first die-cut lines cuts an outer surface of the design layer, and the other side end of the design layer cuts the design layer inwards from lengthwise direction and widthwise direction outer surfaces of the design layer by 5% to 50% relative to a length and a width of the design layer.

3. The artificial nail according to claim 1, wherein a total length of the first die-cut lines formed in the design layer is 3-500% relative to an outer surface length of the design layer, and a total area of the first die-cut lines is 0.5-25% relative to a surface area of the design layer.

4. The artificial nail according to claim 1, wherein the first die-cut lines include at least one of linear die-cut lines having a predetermined width, tapered die-cut lines with a decreasing or increasing width inwards from an outer surface of the design layer, and curved die-cut lines having a predetermined width.

5. The artificial nail according to claim 1, wherein the design layer includes a plurality of unit design layers divided by the plurality of first die-cut lines, and which is adhered to the nail main body by a medium of the adhesive layer.

6. The artificial nail according to claim 5, wherein the design layer further includes a connecting part formed between the first die-cut lines to prevent the plurality of unit design layers from being separated.

7. The artificial nail according to claim 1, further comprising:
a base layer interposed between the design layer and the adhesive layer or stacked on an upper surface of the design layer, the base layer in which a plurality of second die-cut lines is formed at corresponding locations to the plurality of first die-cut lines of the design layer.

8. The artificial nail according to claim 7, wherein the design layer is a transparent or opaque hologram film or sheet, and
the base layer is a transparent or opaque film or sheet printed with at least one color ink or deposited with a metal thin film.

9. The artificial nail according to claim 1, wherein the adhesive layer has a plurality of third die-cut lines formed at corresponding locations to the plurality of first die-cut lines of the design layer.

10. A transfer assembly set for an artificial nail, comprising:
a sticker including a design layer having a plurality of first die-cut lines, an adhesive layer provided below the design layer and peelably adhered to a release sheet, and a base layer interposed between the design layer and the adhesive layer or stacked on an upper surface of the design layer; and
a transfer body including a main body part and an adhesion part provided below the main body part, and to which the design layer, the base layer and the adhesive layer are integrally adhered when the upper surface of the design layer or the base layer adhered to the release sheet is pressed upon contact, wherein the transfer body peels the design layer, the base layer and the adhesive layer from the release sheet, and attaches the design layer, the base layer and the adhesive layer to a nail main body of an artificial nail by pressing the design layer, the base layer and the adhesive layer onto the nail main body upon contact.

11. The transfer assembly set for an artificial nail according to claim 10, wherein tackiness between the adhesive layer and the nail main body is larger than tackiness between the design layer or the base layer and the adhesion part.

12. The transfer assembly set for an artificial nail according to claim 10, wherein tackiness of the adhesive layer is 300-25,000 gf/in, and
tackiness of the adhesion part is 5-15,000 gf/in.

13. The transfer assembly set for an artificial nail according to claim 10, wherein the adhesion part has tackiness, and is formed from a material including one selected from olefin resin, acrylic resin, urethane resin, silicone resin and rubber or mixtures thereof.

14. The transfer assembly set for an artificial nail according to claim 13, wherein the adhesion part is manufactured in a form of cushioned sheet or foam.

15. The transfer assembly set for an artificial nail according to claim 10, wherein the transfer body further includes a pressing part that extends from the main body part and is bent, with a lower surface to which the adhesion part is attached and an upper surface having a flat or curved shape to which pressing is applied, and
the main body part is manufactured from a material that is capable of elastic recovery when pressing the design layer or the base layer upon contact.

16. The transfer assembly set for an artificial nail according to claim 15, wherein the pressing part is provided at two ends of the main body part and each differently sized to match a size of the design layer or the base layer, and
when the pressing part has a curved shape, a widthwise direction radius of curvature of the pressing part is 10-360 mm and a lengthwise direction radius of curvature of the pressing part is 30-400 mm.

17. The transfer assembly set for an artificial nail according to claim 10, wherein surface tension of the release sheet is 36 dyne/cm or less per unit width.
